(19) United States
(12) Patent Application Publication
(10) Pub. No.: US 2007/0111049 A1
(43) Pub. Date: May 17, 2007

(54) Fuel cell unit

(75) Inventors: Yuji Takaiwa, Yokohama-shi (JP); Nobuyasu Tajima, Irvine, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/586,141

(22) Filed: Oct. 24, 2006

(30) Foreign Application Priority Data
Nov. 17, 2005 (JP) 2005-332979

(51) Int. Cl. H01M 8/04

(52) U.S. Cl. 429/17

(57) ABSTRACT

According to one embodiment, a fuel cell unit is provided with a housing, a circulation section which is housed in the housing and in which a fluid is circulated, and a valve which is provided for the circulation section and releases a pressure more than predetermined value produced in the circulation section.

### CROSS-REFERENCE TO RELATED APPLICATIONS

This application is based upon and claims the benefit of priortiy from Japanese Patent Application No. 2005-332979, filed Nov. 17, 2005, the entire contents of which are incorporated herein by reference.

### BACKGROUND

1. Field

One embodiment of the invention relates to a fuel cell unit, for example, a fuel cell unit with a circulation section in which a fluid is circulated.

2. Description of the Related Art

In recent years, small-sized, high-power fuel cell units that require no charging have been notice as power sources for electronic devices, such as portable computers. A direct methanol fuel cell (DMFC) unit that uses, for example, an aqueous methanol solution as its fuel is proposed as a fuel cell unit of this type.

An electromotive section of a DMFC unit performs operation for power generation by causing an aqueous methanol solution and oxygen in air to react chemically with each other. As the power generation advances, by-products in the electromotive section. The DMFC unit includes a circulation section through which the fuel, an oxidant, and the by-products flow into and from the electromotive section.

Afuel cell system with pressure valves is described in Jpn. Pat. Appln. KOKAI Publication No. 2004-127905. This fuel cell system includes a casing, a fuel tank, and an air tank, the tanks being located in the casing. The fuel and air tanks are provided with pressure valves, individually. The pressure valves are controlled by a control section through a converter. The control section operates the pressure valve in the fuel tank to lower pressure in the fuel tank. Thereupon, an aqueous methanol solution is fed from a fuel pack into the fuel tank. Further, the control section operates the pressure valve in the air tank to raise pressure in the air tank. Thus, water that collects in the air tank is discharged to the outside of the air tank.

A part of the circulation section in which a fluid is circulated sometimes may be clogged during operation of the fuel cell unit. If the operation is continued with the circulation section partially clogged, pressure in the circulation section increases so that the interior of the circulation section is highly pressurized. If the circulation section is thus internally pressurized, there is a possibility of a fluid, such as the fuel, water, or steam, leaking out through a structurally weak part of the circulation section. In some cases, moreover, a part of the circulation section may undergo deformation or breakdown, such as cracking.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view of a fuel cell unit according to a first embodiment of the invention;

FIG. 2 is an exemplary perspective view showing a portable computer set on the fuel cell unit according to the first embodiment;

FIG. 3 is an exemplary perspective view of the DMFC unit according to the first embodiment;

FIG. 4 is an exemplary sectional view typically showing the fuel cell unit according to the first embodiment;

FIG. 5 is an exemplary sectional view of a safety valve according to the first embodiment;

FIG. 6 is an exemplary sectional view showing the safety valve of the first embodiment in an on state;

FIG. 7 is an exemplary diagram showing a relationship between temperature and pressure in a circulation section according to a first embodiment;

FIG. 8 is an exemplary sectional view typically showing a fuel cell unit according to a second embodiment of the invention;

FIG. 9 is an exemplary sectional view typically showing a fuel cell unit according to a third embodiment of the invention;

FIG. 10 is an exemplary sectional view of a safety valve according to the third embodiment; and

FIG. 11 is an exemplary sectional view showing a modification of the fuel cell unit according to the third embodiment.

### DETAILED DESCRIPTION

Various embodiments according to the invention will be described hereinafter with reference to the accompanying drawings. In general, according to one embodiment, a fuel cell unit is provided with a housing, a circulation section which is housed in the housing and in which a fluid is circulated, and a valve which is provided for the circulation section and releases a pressure more than predetermined value produced in the circulation section.

Embodiments of the present invention applied to a fuel cell unit will now be described with reference to the accompanying drawings.

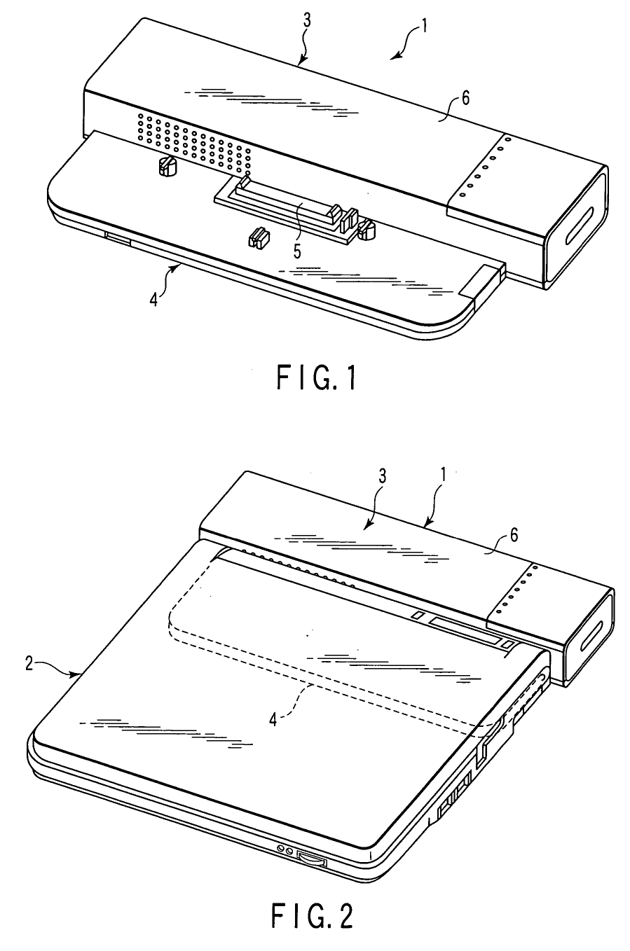

FIGS. 1 to 7 show a fuel cell unit 1 according to a first embodiment of the invention. FIG. 1 shows an outline of the unit 1. The fuel cell unit 1 according to the present embodiment is of the DMFC type. As shown in FIG. 2, the unit 1 has a size such that it can be used as a power source for, e.g., a portable computer 2.

As shown in FIG. 1, the fuel cell unit 1 includes a unit body 3 and a setting section 4. The unit body 3 has an elongate shape extending along the longitudinal direction of the portable computer 2. The setting section 4 protrudes horizontally from the front end of the unit body 3. The rear end portion of the computer 2 is set on the setting section 4. A power supply connector 5 is located on the upper surface of the setting section 4. The connector 5 is connected electrically to the computer 2 when it is placed on the setting section 4.

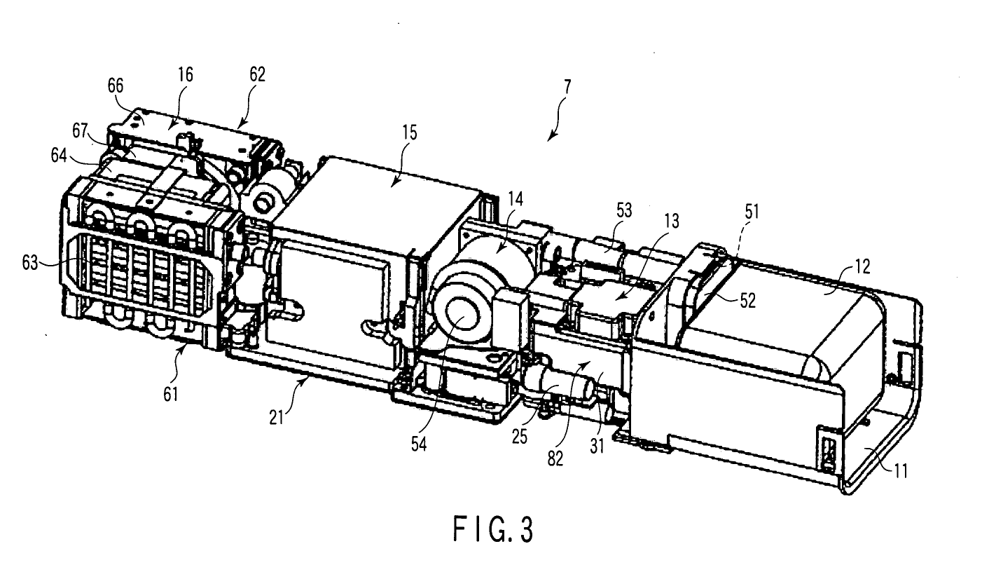

As shown in FIG. 1, the unit body 3 is provided with a housing 6. The housing 6 contains a DMFC unit 7 therein, as shown in FIG. 3. The DMFC unit 7 includes a holder 11, fuel cartridge 12, mixing section 13, intake section 14, DMFC stack 15, cooling section 16, exhaust section 17, control section 18, and safety valve 19.

The mixing section 13, intake section 14, DMFC stack 15, cooling section 16, exhaust section 17, and pipes that connect those sections cooperate with one another to form a part of a circulation section 21 in which a fluid is circulated. The fuel cartridge 12 is an example of a fuel container.

As shown in FIG. 3, the fuel cartridge 12 is removably attached to the holder 11. The fuel cartridge 12 contains therein high-concentration methanol as a liquid fuel to be used for power generation, for example. A methanol-soluble odorant, for example, is added to this methanol. An example of the odorant that is mixed into the fuel for fuel cells may be one that can produce a sufficient odor despite its scantiness and has low adsorptivity to pipes, containers, etc. The odorant used may be one that contains, for example, a pyridine derivative and a solid-state compound.

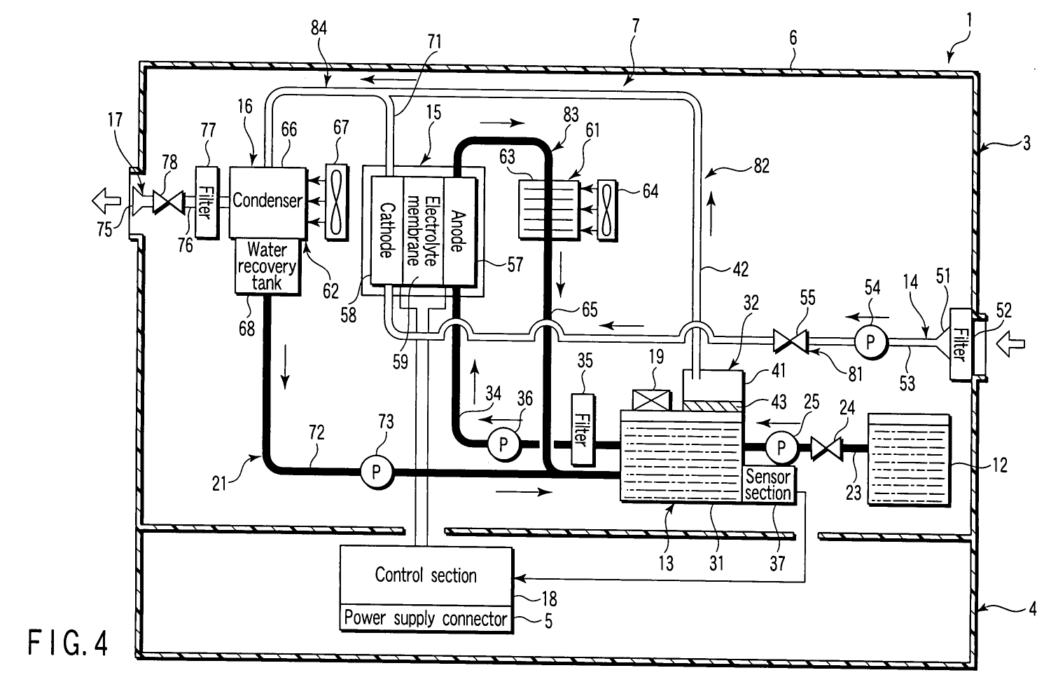

As shown in FIG. 4, the fuel cartridge 12 that is attached to the holder 11 is connected to the mixing section 13 by a first fuel supply pipe 23. The first fuel supply pipe 23 is an example of a first pipe. A first valve 24 and a fuel pump 25 are provided in the middle of the first pipe 23. The first valve 24 can be switched between a position in which it allows a passage of the pipe 23 to open and a position in which it closes the passage. The fuel pump 25 feeds the methanol from the fuel cartridge 12 into the mixing section 13.

As shown in FIG. 4, the mixing section 13 is provided with a mixing tank 31 and a gas-liquid separator section 32. The tank 31 communicates with the first fuel supply pipe 23. The tank 13 is supplied with the methanol from the fuel cartridge 12. In the mixing tank 31, the supplied high-concentration methanol is diluted to form an aqueous solution of methanol with a concentration of several to tens of percent.

As shown in FIG. 4, the mixing tank 31 is connected to the DMFC stack 15 by a second fuel supply pipe 34. A filter 35 and a liquid pump 36 are provided in the middle of the supply pipe 34. The liquid pump 36 feeds the aqueous methanol solution generated in the mixing tank 31 into the DMFC stack 15.

The mixing tank 31 is provided with a sensor section 37. The sensor section 37 includes a liquid quantity sensor, a temperature sensor, and a concentration sensor. The sensor section 37 detects some pieces of information, such as a liquid quantity, temperature, and the concentration of the aqueous methanol solution in the mixing tank 31, and delivers them to the control section 18.

The gas-liquid separator section 32 is provided with a gas-liquid separation chamber 41 and a first exhaust pipe 42. The separation chamber 41 is formed integrally with the mixing tank 31 and communicates internally with the tank 31. The chamber 41 has a gas-liquid separation membrane 43. The membrane 43 is situated on a boundary between the chamber 41 and the tank 31 and divides the chamber 41 and the tank 31. The first exhaust pipe 42 connects the gas-liquid separation chamber 41 to the cooling section 16 and guides a gas in the chamber 41 into the exhaust section 17 through the cooling section 16.

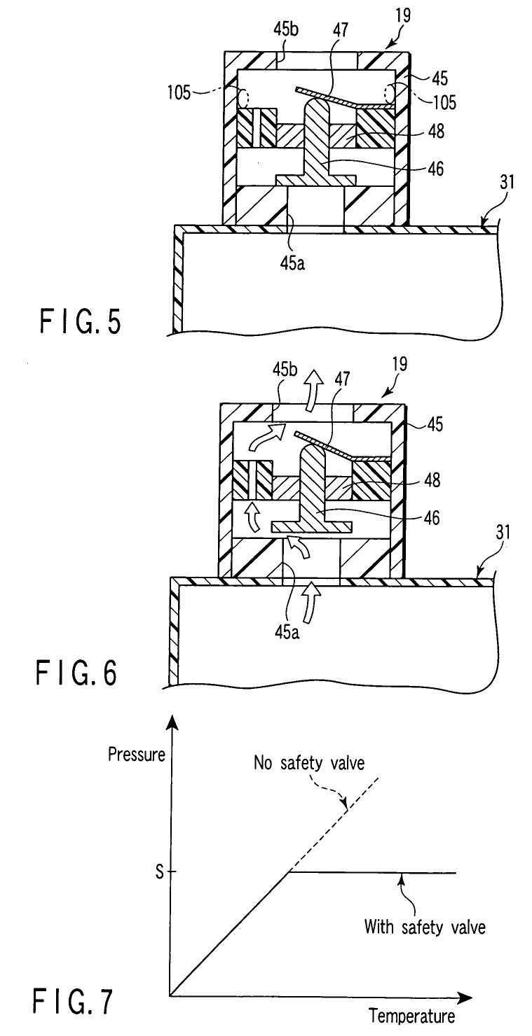

As shown in FIG. 4, the safety valve 19 is provided on, for example, a ceiling of the mixing tank 31. Much of a gas that is contained in the fluid in the tank 31 gathers in an upper part of the tank 31. The safety valve 19 is an example of a valve that releases a pressure of a predetermined or higher value produced in the circulation section 21. As shown in FIG. 5, the valve 19 includes a case 45, valve body 46, leaf spring 47, and bearing 48. The case 45 is mounted on a top surface of the mixing tank 31. The case 45 has a first opening portion 45a that opens into the mixing tank 31 and a second opening portion 45b that opens outward from the tank 31. The valve body 46 is housed in the case 45. The valve body 46 is supported by the bearing 48 in such a manner that the valve body 46 is movable between a position in which it closes the first opening portion 45a and a position in which it allows the opening portion 45a to open. The leaf spring 47 is an example of an urging mechanism. It urges the valve body 46 toward the position in which the first opening portion 45a is closed. The urging mechanism is not limited to the leaf spring 47 but may be any other spring, such as a coil spring, or an elastic member such as rubber.

As shown in FIG. 3, the intake section 14 is provided with an intake port 51 that opens outward from the DMFC unit 7. An air filter 52 is attached to the port 51. The intake section 14 introduces the outside air into the DMFC unit 7 through the intake port 51. As shown in FIG. 4, the intake section 14 is connected to the DMFC stack 15 by an air supply pipe 53. The pipe 53 is an example of a second pipe.

An air pump 54 and a second valve 55 are provided in the middle of the air supply pipe 53. The pump 54 supplies the DMFC stack 15 with air that is introduced through the intake port 51. The second valve 55 can be switched between a position in which it allows a passage of the pipe 53 to open and a position in which it closes the passage.

The DMFC stack 15 is an example of an electromotive section. It includes an anode 57, cathode 58, and electrolyte membrane 59. The electrolyte membrane 59 is interposed between the anode 57 and the cathode 58 and divides these electrodes. The anode 57 is supplied with the aqueous methanol solution from the mixing tank 31. The cathode 58 is supplied with an oxidant, i.e., air, from the intake section 14.

The DMFC stack 15 causes the aqueous methanol solution and oxygen in the air to react chemically with each other, thereby generating electric power. This operation for power generation produces, as by-products, carbon dioxide at the anode 57 and steam at the cathode 58.

The cooling section 16 is provided with a first cooling mechanism 61 and a second cooling mechanism 62. The first cooling mechanism 61 has a first condenser 63 and a first cooling fan 64. The fan 64 is driven to cool the condenser 63.

As shown in FIG. 4, the anode 57 of the DMFC stack 15 is connected to the mixing tank 31 by a fuel return pipe 65. The first cooling mechanism 61 is provided in the middle of the pipe 65. The carbon dioxide generated at the anode 57 and unreacted methanol are cooled as they pass through the first condenser 63 after having passed through the anode 57, and are supplied back to the mixing tank 31.

The second cooling mechanism 62 has a second condenser 66, second cooling fan 67, and water recovery tank 68. The second cooling fan 67 is driven to cool the condenser 66. As shown in FIG. 4, the cathode 58 of the DMFC stack 15 is connected to one end of a second exhaust pipe 71. The other end of the pipe 71 joins the first exhaust pipe 42 and is connected to the second condenser 66. The steam produced at the cathode 58 and air are delivered to the second condenser 66 after having passed through the cathode 58. The steam delivered to the second condenser 66 is cooled to be condensed and is recovered as water in the water recovery tank 68.

As shown in FIG. 4, the water recovery tank 68 is connected to the mixing tank 31 by a recovery pipe 72. A recovery pump 73 is provided in the middle of the pipe 72. It supplies the water recovered in the water tank 68 back to the tank 31.

As shown in FIG. 4, the exhaust section 17 is provided with an exhaust port 75 that opens outward from the circulation section 21. It has a third exhaust pipe 76 that connects the second condenser 66 to the exhaust port 75. The third exhaust pipe 76 is an example of a third pipe. A filter 77 and a third valve 78 are provided in the middle of the pipe 76. The third valve 78 can be switched between a position in which it allows a passage of the pipe 76 to open and a position in which it closes the passage. When the third valve 78 is closed, the exhaust section 17 is closed externally.

The first, second, and third valves 24, 55 and 78 cooperate with one another to serve as a valve mechanism 81 that hermetically closes most divisions of the DMFC unit 7. Further, the intake section 14, cathode 58 of the DMFC stack 15, second cooling mechanism 62, mixing tank 31, vapor-liquid separator section 32, exhaust section 17, and pipes that connect those sections cooperate with one another to form a part of a gas circulation section 82 in which a gas is circulated.

The control section 18 is housed in the setting section 4. It serves to monitor the states of the mixing section 13, intake section 14, DMFC stack 15, cooling section 16, exhaust section 17, etc. and control the operations of these units 13 to 17. Further, the control section 18 supplies the power supply connector 5 with electric power that is generated in the DMFC stack 15.

The following is a description of the function of the fuel cell unit 1. The general operation of the DMFC unit 7 will first be described with reference to FIG. 4.

The methanol that is stored in the fuel cartridge 12 is fed into the mixing tank 31 through the first fuel supply pipe 23, whereupon it is diluted in the tank 31. The resulting aqueous methanol solution diluted in the mixing tank 31 is delivered to the anode 57. On the other hand, the cathode 58 is supplied with air through the intake section 14. The DMFC stack 15 performs operation for power generation by causing the aqueous methanol solution and oxygen in the air to react chemically with each other. As this operation advances, carbon dioxide and steam are produced at the anode 57 and the cathode 58, respectively.

The carbon dioxide and unreacted methanol having passed through the anode 57 are cooled by the first cooling mechanism 61 and supplied back to the mixing tank 31. The aqueous methanol solution supplied back to the tank 31 has its concentration adjusted as a fresh aqueous methanol solution, and is supplied again to the anode 57 to be used for power generation.

The carbon dioxide supplied back to the mixing tank 31 is separated from the aqueous methanol solution by being passed through the gas-liquid separation membrane 43, and is temporarily stored in the gas-liquid separation chamber 41. The carbon dioxide in the chamber 41 is delivered to the second cooling mechanism 62 through the first exhaust pipe 42. The carbon dioxide delivered to the cooling mechanism 62 is further fed to the exhaust section 17 and discharged to the outside of the circulation section 21.

On the other hand, the steam and air having passed through the cathode 58 are cooled by the second cooling mechanism 62, whereupon the steam condenses. Thus, air is separated from water. The separated air is discharged to the outside of the circulation section 21 through the exhaust section 17. The separated water is supplied back to the mixing tank 31 and used to dilute the aqueous methanol solution.

The function of the safety valve 19 will now be described with reference to FIGS. 5 to 7.

When the fuel cell unit 1 is not in use, the first, second, and third valves 24, 55 and 78 are closed. When the valves 24, 55 and 78 are closed, most divisions of the circulation section 21, exclusive of the upstream end portion of the first fuel supply pipe 23, the upstream end portion of the air supply pipe 53, and the downstream end portion of the third exhaust pipe 76, are hermetically closed. If most divisions of the circulation section 21 are hermetically closed, a substance, such as a liquid fuel, in the circulation section 21 can be prevented from leaking out of it.

If the fuel cell unit 1 is left with any divisions of the circulation section 21 hermetically closed, the temperature of the fluid in the circulation section 21 increases when the outside air temperature is high, for example. In FIG. 7, a broken line shows a relationship between temperature and pressure in the circulation section 21 without the safety valve 19. If the temperature in the circulation section 21 increases, as shown in FIG. 7, the pressure in the circulation section 21 also increases correspondingly.

If a passage or a container in the circulation section 21 is partially clogged during the operation of the fuel cell unit 1, the pressure in the circulation section 21 also increases.

The safety valve 19 according to the present embodiment is actuated when a predetermined value (e.g., value S in FIG. 7) is exceeded by the pressure in the circulation section 21. Thus, the valve body 46 moves so as to allow the first opening portion 45a to open when the force of the leaf spring 47 is surpassed by the pressure in the mixing tank 31 that acts on the valve body 46, as shown in FIG. 6. When the first opening portion 45a is open, the gas in the mixing tank 31 flows out of it through the safety valve 19, as indicated by hollow arrows. Thus, the safety valve 19 releases a pressure of a predetermined or higher value in the mixing tank 31. By doing this, the pressure in the mixing tank 31 can be restrained from increasing above the predetermined value, as indicated by a solid line in FIG. 7.

The mixing tank 31 is connected directly or indirectly to all of the other units that constitute the circulation section 21, that is, the vapor-liquid separator section 32, intake section 14, DMFC stack 15, cooling section 16, exhaust section 17, first and second fuel supply pipes 23 and 34, air supply pipe 53, first, second, and third exhaust pipes 42, 71 and 76, fuel return pipe 65, and recovery pipe 72. If the pressure in the mixing tank 31 is released, pressures in those units are also restrained from increasing.

Thus, the pressure in the circulation section 21 cannot be increased above a predetermined level even if the temperature in the circulation section 21 continues to increase, as shown in FIG. 7.

In the present embodiment, the odorant is previously added to the liquid fuel. When the safety valve 19 is actuated to open the first opening portion 45a, therefore, the odor of the odorant gets out of the housing 6 of the fuel cell unit 1. A user can recognize the actuation of the safety valve 19 by smelling the odor of the odorant and take measures such as to stop the operation of the fuel cell unit 1 or ventilate the room.

According to the fuel cell unit 1 constructed in this manner, a trouble that is attributable to the internal pressure of the circulation section 21 can be prevented. More specifically, if the pressure in the circulation section 21 is expected to exceed an allowable value, the safety valve 19 is actuated before the allowable value is exceeded. Therefore, the pressure in the circulation section 21 can always be kept at or below the allowable value. Thus, leakage of the fuel or water from the circulation section 21 that is attributable to high pressure can be prevented. Further, any part of the circulation section 21 can be prevented from being damaged due to the internal pressure.

Since the fuel cell unit 1 is provided with the safety valve 19, moreover, it can be reduced in size. If the fuel cell unit 1 has no safety valve, the strength of the members of the circulation section 21 should be made increased to ensure that the circulation section 21 is not damaged when the pressure therein is increased. Since the fuel cell unit 1 has the safety valve 19, however, it is necessary only that the members of the circulation section 21 have a minimum strength such that they can comply with an optionally set allowable value. Thus, the individual members can be reduced in size.

Since the fuel cell unit 1 has the valve mechanism 81 that hermetically closes at least some divisions of the circulation section 21, leakage of the fluid from the circulation section 21 can be minimized when the unit 1 is nonoperating.

The circulation section 21 has a region in which a liquid, such as the aqueous methanol solution or water, is circulated and a region in which a gas, such as air or carbon dioxide, is circulated. The safety valve 19 may be located in either of these regions.

If the safety valve 19 is located in the region in which the liquid is circulated, something like a tank is provided so as to recover the liquid that leaks out of the circulation section 21 through the valve 19 when the valve 19 is actuated. If the safety valve 19 is located in the region in which the gas is circulated, on the other hand, it is unnecessary to provide any special tank or the like. This is efficient to reduction of the fuel cell unit 1 in size and in cost.

The safety valve 19 may be attached to the mixing tank 31. The circulation section 21 roughly includes an anode system passage 83 and a cathode system passage 84. The anode system passage 83 is a passage through which the aqueous methanol solution or some other liquid fuel flows. The passage 83 includes, for example, the second fuel supply pipe 34, anode 57, first cooling mechanism 61, fuel return pipe 65, etc. On the other hand, the cathode system passage 84 is a passage through which the oxidant, i.e., air, or the product at the cathode 58 flows. The passage 84 includes, for example, the air supply pipe 53, cathode 58, second exhaust pipe 71, second cooling mechanism 62, recovery pipe 72, etc.

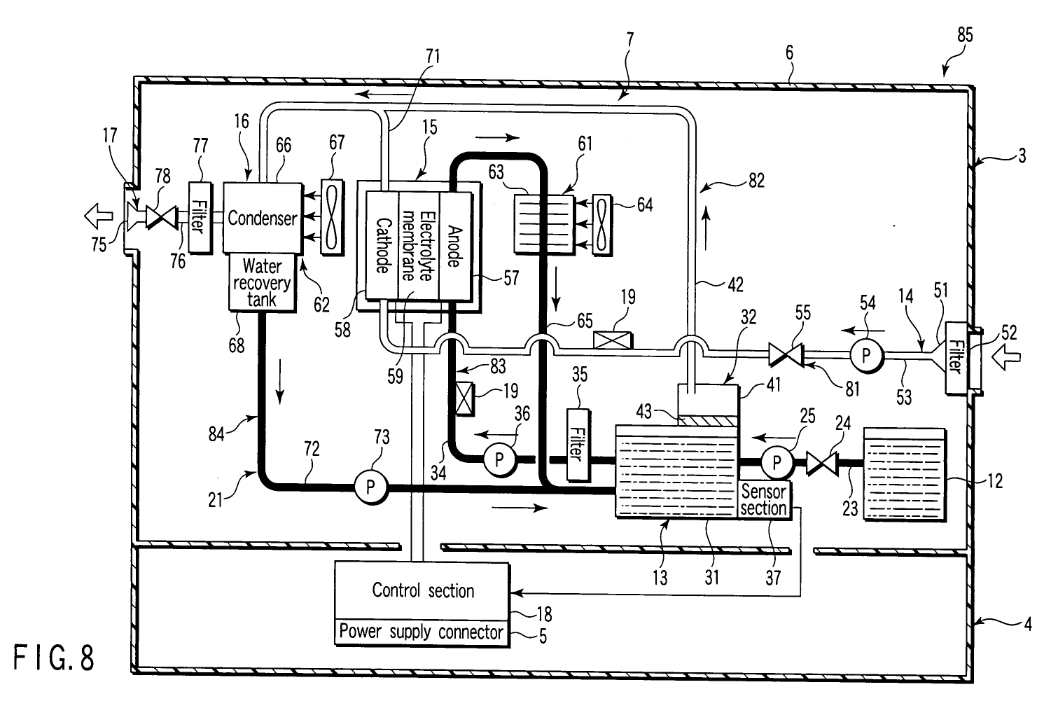

The safety valve 19 may be provided in either the anode system passage 83 or the cathode system passage 84. If the circulation section 21 has a complicated piping arrangement, a pressure increase in the cathode system passage 84 may possibly fail to be fully restrained even when the safety valve 19 in, for example, the anode system passage 83 is actuated. Therefore, at least one safety valve 19 may be provided in each of the passages 83 and 84, as shown in FIG. 8.

On the other hand, the mixing tank 31 is a region at which the anode system passage 83 and the cathode system passage 84 join each other. Specifically, the tank 31 communicates intimately with each of the passages 83 and 84. When the safety valve 19 that is provided on the mixing tank 31 is actuated, therefore, it can restrain the pressure in the passages 83 and 84 from increasing. Thus, by providing the mixing tank 31 with the one safety valve 19, the same effect can be obtained as in the case where two safety valves 19 are provided separately in the anode system passage 83 and the cathode system passage 84.

The safety valve 19 according to the present embodiment need not be provided with any special attachment member, such as a pressure sensor or control section. However, the object that is to restrain the occurrence of trouble in the circulation section 21 can be also achieved if a pressure sensor is located in the circulation section 21 with use of a safety valve that is controlled by a control section, for example.

A fuel cell unit 85 according to a second embodiment of the invention will now be described with reference to FIG. 8. Like numerals are used to designate like portions of the fuel cell unit 1 of the first embodiment with the same functions, and a description of those portions is omitted.

The fuel cell unit 85 has two safety valves 19, first and second. The first safety valve 19 is provided in the middle of an air supply pipe 53. The second safety valve 19 is provided in a second fuel supply pipe 34. Thus, the two safety valves 19 are provided on the anode system passage 83 and the cathode system passage 84, individually.

The fuel cell unit 85 constructed in this manner, like the fuel cell unit 1 according to the first embodiment, is configured so that occurrence of trouble that is attributable to the internal pressure of the circulation section 21 can be restrained.

The circulation section 21 has a complicated piping arrangement. Even when the safety valve 19 in, for example, the anode system passage 83 is actuated, therefore, a pressure increase in the cathode system passage 84 may possibly fail to be fully restrained. If at least one safety valve 19 is provided in each of the passages 83 and 84, however, the possibility of such a failure is reduced.

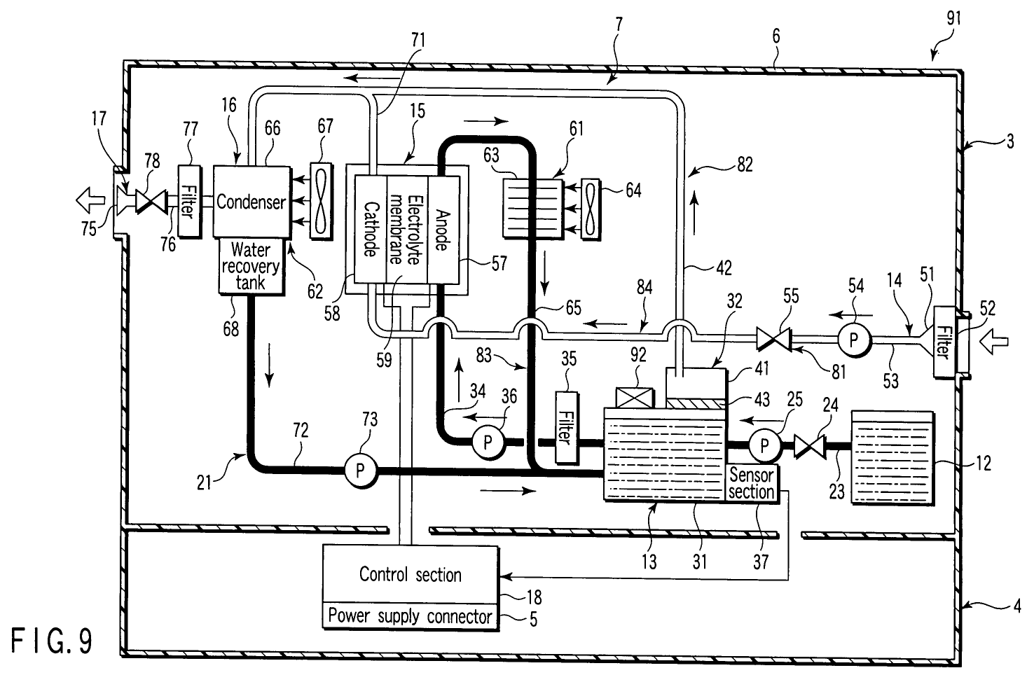

A fuel cell unit 91 according to a third embodiment of the invention will now be described with reference to FIGS. 9 to 11. Like numerals are used to designate like portions of the fuel cell unit 1, 85 of the first and second embodiments with the same functions, and a description of those portions is omitted.

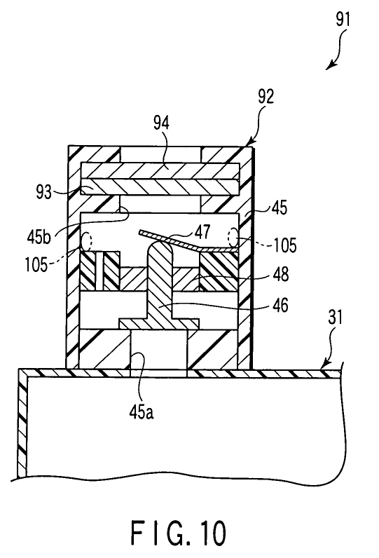

As shown in FIG. 9, the fuel cell unit 91 has a circulation section 21 and a safety valve 92. As shown in FIG. 10, the safety valve 92 includes a case 45, valve body 46, leaf spring 47, bearing 48, liquid absorbing sheet 93, and filter 94. The liquid absorbing sheet 93 is an example of a liquid absorbing member. It is mounted so as to cover a second opening portion 45b. The sheet 93 is formed of a liquid absorbing material, such as sponge or paper, and absorbs a liquid that adheres to its surface.

The filter 94 is mounted so as to cover the second opening portion 45b. An example of the filter 94 can remove vaporized methanol that is contained in a gas.

The fuel cell unit 91 constructed in this manner, like the fuel cell unit 1 according to the first embodiment, is configured so that occurrence of trouble that is attributable to the internal pressure of the circulation section 21 can be restrained.

According to the fuel cell unit 91 of the present embodiment, moreover, leakage of substance, such as methanol vapor, can be restrained from flowing out of a DMFC unit 7. That is, some of a gas in a mixing tank 31 flows out of the DMFC unit 7 when the safety valve 92 is actuated. Some of the gas in the tank 31 contains methanol vapor.

The safety valve 92 according to the present embodiment has the filter 94, which removes a substance, such as methanol vapor, contained in the gas as the gas passes through the valve 92.

According to the fuel cell unit 91 of the present embodiment, moreover, leakage of liquid can be restrained from leaking out of the DMFC unit 7. That is, when the safety valve 92 is actuated, some of an aqueous methanol solution in the mixing tank 31 is apt to leak out of the DMFC unit 7 through the safety valve 92. The safety valve 92 according to the present embodiment has the liquid absorbing sheet 93, whereby the liquid having penetrated into the valve 92 is absorbed and prevented from leaking out of the DMFC unit 7.

The safety valve 92 need not hold both the filter 94 and the liquid absorbing sheet 93, but may alternatively use only one of these elements, depending on the characteristics of the fuel cell unit to which the embodiment of the invention is applied. Further, the attachment of the filter 94 and the liquid absorbing sheet 93 are not limited to the position according to the present embodiment. For example, the filter 94 may be located nearer to the valve body 46 than the liquid absorbing sheet 93 is. Some of conventional, commercially available filters cannot fulfill their essential function if a liquid adheres to their surface. If one such filter is used, the liquid absorbing sheet 93 is suitably located on the side nearer to the mixing tank 31, as in the present embodiment.

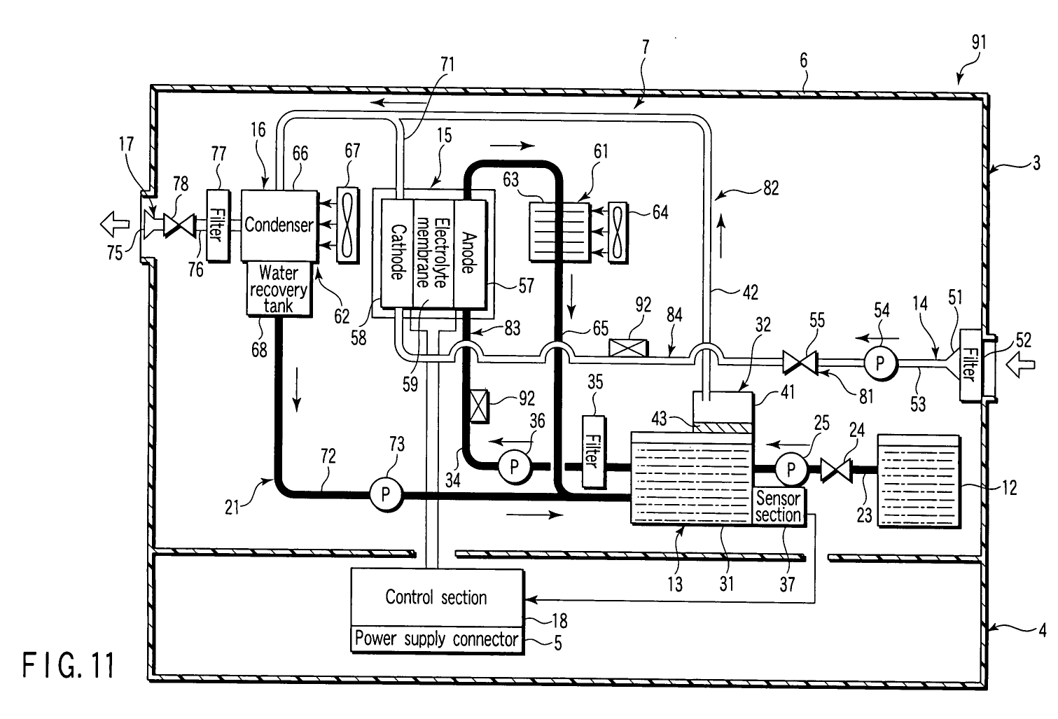

Furthermore, the liquid absorbing sheet 93, for example, need not cover the second opening portion 45b, but may be located along the inner surface of the case 45 of the safety valve 92 without failing to produce its effect as a liquid absorbing member. As shown in FIG. 11, the safety valve 92 may be provided in each of passages, an anode system passage 83 and a cathode system passage 84.

Although the fuel cell units 1, 85 and 91 according to the first, second, and third embodiments have been described herein, it is to be understood that the present invention is not limited to these embodiments. The components of the fuel cell units according to these three embodiments may be suitably combined according to the purpose.

For example, the location of the safety valves 19 and 92 is not limited to the positions described in connection with the first and second embodiments, but may be in any region in which the fluid can be circulated without failing to fulfill their function. For example, the construction of each safety valve is not limited to those of the embodiments. The valve may be of any shape or configuration as long as it is designed to release the pressure in the circulation section 21 when it reaches a predetermined or higher value. Further, a plurality of safety valves may be provided depending on the size, construction, and function of the fuel cell unit.

Instead of adding the odorant to the fuel, for example, odorizors 105 may be located in the safety valve 19 or 92, as indicated by two-dot chain lines in FIG. 5 or 10. Each odorizor 105 may be one that produces an odor by reacting directly with the fuel or water or one formed of an inherently odoriferous material contained in a capsule that is soluble in the fuel or water. Further, the odorizors 105 may be located outside the case 45 instead of being located inside.

The embodiments of the present invention are not limited to DMFC units, but may be also applied to fuel cell units that use alcohols, such as ethanol, or some other fluid fuels. Further, the embodiments of the invention are not limited to fuel cell units for portable computers, but may be also applied to fuel cell units for electronic devices, such as cell phones, digital cameras, etc., or vehicles such as automobiles.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A fuel cell unit comprising:
a housing;
a circulation section which is housed in the housing and in which a fluid is circulated; and
a valve which is provided for the circulation section and releases a pressure more than predetermined value produced in the circulation section.

2. A fuel cell unit according to claim 1, wherein the circulation section includes a valve mechanism which hermetically closes at least a part of the circulation section, the valve being located in the part hermetically closed by the valve mechanism.

3. A fuel cell unit according to claim 1, wherein the circulation section includes a gas circulation section in which a gas contained in the fluid is circulated, the valve being located in the gas circulation section.

4. A fuel cell unit according to claim 1, further comprising a fuel container which is housed in the housing and stored with a liquid fuel, and wherein the circulation section includes a mixing tank in which the liquid fuel supplied from the fuel container is diluted, an electromotive section which includes an anode and a cathode and performs operation for power generation by causing the liquid fuel diluted in the mixing tank and oxygen in air to react chemically with each other, an intake section which supplies the air to the electromotire section, a cooling section including a first cooling mechanism which cools a fluid having passed through the anode and supplies the fluid back to the mixing tank and a second cooling mechanism which cools a fluid having passed through the cathode and supplies the fluid back to the mixing tank, the valve being provided on the mixing tank.

5. A fuel cell unit according to claim 4, wherein the circulation section includes a first pipe which connects the fuel container to the mixing tank, a first valve which closes the first pipe, a second pipe which connects the intake section to the electromotive section, a second valve which closes the second pipe, an exhaust section which exhausts a gas supplied back to the mixing tank, and a third valve which externally closes the exhaust section.

6. A fuel cell unit according to claim 4, wherein the valve includes a case including a first opening portion which opens into the mixing tank and a second opening portion which opens outward from the mixing tank, a valve body housed in the case, and an urging mechanism which urges the valve body to close the first opening portion.

7. A fuel cell unit according to claim 6, further comprising a filter which covers the second opening portion of the valve.

8. A fuel cell unit according to claim 7, further comprising a liquid absorbing member located in the case of the valve.

9. A fuel cell unit according to claim 8, wherein the fluid circulated in the circulation section contains odorant.

10. A fuel cell unit according to claim 1, wherein the circulation section includes an electromotive section including an anode and a cathode, an anode system passage which is connected to the anode and supplies the liquid fuel to the anode and through which a product from the anode flows, a cathode system passage which is connected to the cathode and supplies an oxidant to the cathode and through which a product from the cathode flows, and a tank connected to both the anode system passage and the cathode system passage, the valve being provided on the tank.

11. A fuel cell unit according to claim 10, wherein the valve is located in that region of the tank in which a gas contained in the fluid gathers.

12. A fuel cell unit according to claim 11, wherein the valve includes a case including a first opening portion which opens into the tank and a second opening portion which opens outward from the tank, a valve body housed in the case, and an urging mechanism which urges the valve body to close the first opening portion.

13. A fuel cell unit according to claim 12, further comprising a filter which covers the second opening portion of the valve.

14. A fuel cell unit according to claim 13, further comprising a liquid absorbing member located in the case of the valve.

15. A fuel cell unit according to claim 1, wherein the fluid circulated in the circulation section contains odorant.
